(19) United States
(12) Patent Application Publication
(10) Pub. No.: US 2024/0139845 A1
(43) Pub. Date: May 2, 2024

(54) METHOD FOR ELECTRICAL DISCHARGE MACHINING

(71) Applicant: Agie Charmilles SA, Losone (CH)

(72) Inventor: Marco BOCCADORO, Verscio (CH)

(21) Appl. No.: 18/381,333

(22) Filed: Oct. 18, 2023

(30) Foreign Application Priority Data
Oct. 31, 2022 (EP) 22 204 608.8

(51) Int. Cl. B23H 7/14

(52) U.S. Cl. CPC B23H 7/14

(57) ABSTRACT

A method for electrical discharge machining (EDM) a workpiece by means of a train of machining pulses. During the machining time the machining pulses are applied to the working gap between workpiece and electrode.

An open voltage is first applied, the ignition delay time t_{d} is measured, then, at the beginning of the discharge, its fall time t_{f} is measured, and certain shape features (e.g. the pedestal and ramp) of the pulse are adapted in real time for the very same discharge, as a function of said ignition delay time and/or fall time. Moreover, instead of shaping the very same discharge, one or more subsequent discharges can be shaped as a function of t_{d} and/or t_{f} of a single discharge, or of an average of t_{d} and/or t_{f} over several discharges.

### CROSS-REFERENCE TO RELATED APPLICATIONS

This application claims the benefit and priority of European Patent Application No. 22 204 608.8 filed Oct. 31, 2022. The entire disclosure of the above application is incorporated herein by reference.

### BACKGROUND OF THE INVENTION

### Technical Field

The invention relates to a method for electrical discharge machining (EDM) of a workpiece by a tool electrode.

### Discussion

In EDM a train of machining pulses is applied to the working gap between workpiece and electrode, whereby the workpiece is machined. To monitor the process, the voltage and current profile across the working gap with time is sensed. From the pulse voltage profile of the voltage applied to the working gap at the time, characteristic values are derived, such as ignition delay time, average pulse voltage, etc. In particular, the measured ignition delay time can be used to control the interelectrode distance, or gap width, since it is known that the ignition delay is proportional to the gap width, i.e. as disclosed in DE 22 50 872. The measured ignition delay time t_{d} is compared to a corresponding reference value t_{dref} and their difference is used to control the axes position and thus the interelectrode gap width.

One problem of the EDM process is that the tool electrode is prone to wear. As far as the current pulses are concerned, it is known from the state of the art to apply stepped shapes or trapezoidal shapes, in order to reduce the tool electrode wear (e.g. de Bruyn, H. E. (1967). “Slope control: A great improvement in spark erosion”. CIRP Annals, 16(2), pp. 183-191).

The problem of the known method, which apply a slope at the beginning of the current pulse to achieve a low wear, is that the material removal rate (MRR) is reduced. Moreover, if the initial current pedestal is too small, the initial energy will not be sufficient to sustain a stable plasma column and a discharge, causing a sequence of pulse interruptions and reignitions, increasing the tool electrode wear.

### SUMMARY OF THE INVENTION

It is an aspect of this invention to provide a method to simultaneously achieve a high material removal rate (MRR) and low electrode wear.

The present invention is related to a method for electrical discharge machining of a workpiece by a tool electrode, wherein a plurality of discrete electrical discharge machining pulses are applied to a gap between the work piece and the tool electrode.

The method includes:
an open voltage Uₒ is applied between the electrode and the work piece to induce a discharge;
a gap voltage U_{Gap} is measured;
at least one time parameter related to the gap voltage is computed;
shape characteristics of a current pulse is determined based on the determined at least one time parameter; and
the current pulse is generated according to the determined shape characteristics and applied to the electrode.

The aspect of the present invention is to reduce the tool electrode wear by at the same time, having a high material removal rate (MRR). The invention achieves this aspect by adapting the current pulse in real time, more specifically by adapting the current pulse shape in dependency of the time parameters of the measured gap voltage. The current pulse shape is not defined in advance before starting the machining, but is adaptively defined during the machining. As known, electrical discharge machining is a stochastic process, thus each discharge process can be different. The method of the present invention provides the advantage that the shape of each individual machining pulse can be adjusted in real time based on the actual gap conditions. Moreover, since the current pulse applied directly influences the tool wear and the material removal rate, adjusting the current pulse shape in consideration of the actual gap conditions can optimize both, the tool wear and the material removal rate.

At the beginning of the machining pulse, an open voltage Uₒ is applied between the electrode and the work piece to induce a discharge. When the discharge channel is formed, the machining current pulse is applied for the machining of the workpiece. The current pulse is critical concerning the shape and the amplitude. The voltage across the gap is continuously measured during the machining and compared with threshold voltages to monitor and to control the electrical discharge machining process. Therefore, certain characteristic time parameters related to the measured voltage pulse can be determined. These time parameters are important indicators, e.g. for the gap width, for the condition of the gap, for the timing of applying the current pulse and the amplitude of the current pulse to be applied.

In particular, the time parameter related to the sensed voltage pulse is an ignition delay time t_{d} or a voltage fall time t_{f} or both. The time parameter reflects the actual gap condition. According to the invention, the time parameter is used as wear indicator.

The ignition delay time t_{d} and the fall time t_{f} can be computed in known manner, e.g. as disclosed in the Dirk Dauw, dissertation KU Leuven, “On line identification and Optimization of electro-discharge machining”, 1985 (chapter 2.2.).

The open voltage Uₒ is applied to start the actual pulse. From the passing of a threshold at the rising voltage it is derived that the no-load voltage has been reached. The discharge occurs with a time delay called as ignition delay time t_{d}. After the ignition, the gap voltage falls sharply from the open voltage Uₒ to the erosion voltage Uₑ. In practice, the fall time t_{f} is computed by determining the time interval when the sensed gap voltage falls from a first threshold voltage to a second threshold voltage value.

In a preferred variant, the ignition delay time is determined and used to determine the shape characteristics to be applied for the present current pulse. The ignition delay time, or, a derived value can be used to control the interelectrode distance or gap, since it is proportional to gap width. The ignition delay time is normally available for the servo control of the machine tool. Thus, using the ignition delay time as time parameter to define the shape of the current pulse doesn't require additional measurement and calculation. In another variant, the fall time t_{f} is determined and used to determine the shape characteristics of the present current pulse.

In a further variant, both, the ignition delay time t_{d} and the fall time t_{f} are determined and used to determine the shape characteristics of the present current pulse.

In order to ease the implementation of the method, a plurality of predefined shape characteristics are stored in a memory. The suitable shape characteristics of the current pulses for the determined time parameter can be selected from the memory. Moreover, a fast selection of the shape characteristics from the memory is preferred to enable to apply the current pulse in real time. This is achieved e.g. by normalization of the time parameter. The normalization enables to convert the time into a number, which can be used as a pointer to quickly access the stored shape characteristics of the current pulses. A suitable reference for the normalization of the ignition delay is the pulse duration tᵢ. The fall time t_{f} is very short, some tenth of nanoseconds, so that pulse duration tᵢ is not ideal to be applied for normalization. The fall time is preferably normalized with reference to a reference timeframe T_{ff}, which is sized to include the range of the time parameter, e.g. the fall times.

Thus, in a variant, the determined time parameter is normalized with reference to the pulse duration tᵢ or with reference to a reference timeframe T_{ff}. The normalized value of the time parameter is used as a pointer to the memory location that contains the suitable shape characteristics of the current pulse. The current pulse is generated according to the corresponding shape characteristics determined based on the normalized value of the time parameter and applied to the tool electrode.

In one variant, the normalized ignition delay time t_{d %} (e.g. t_{d}/tᵢ) is computed and used to determine the shape characteristics of the current pulses.

In a variant, the normalized fall time t_{fn} (e.g. t_{f}/T_{ff}) is computed and used to determine the shape characteristics of the current pulses. For instance, the fall time t_{f} is normalized using to a reference timeframe T_{ff}. The timeframe T_{ff} has a total length L_{Tff} and can be divided into a plurality of fields n_{Tff}. Each of the field has a time range of L_{Tff}/N_{Tff}. For example, the timeframe has a total length of 400 ns and is divided into 40 fields, so that each field has a time range of 10 ns (L_{Tff}/N_{Tff}=400 ns/40=10 ns). The present fall time t_{f} is then assigned to a field which serves as a pointer to the memory location that contains the suitable shape characteristics of the current pulse.

In a further variant, a combination of the normalized values of two time parameters, in particular the combination of the normalized ignition delay time t_{d %} and the normalized fall time t_{f100} is used as a pointer to a memory location that contains the shape characteristics of the current pulse.

A lookup table including the normalized values of the time parameters and the corresponding shape characteristics can be stored in the control unit of the machine tool, or more preferably, in the generator control itself, in order to provide the real time pulse shaping with minimum delay.

The shape characteristics controlled in real time include one or more features of the current pulse shape. According to the present invention, the most important of the current pulse features which are adapted to the gap conditions based on the time parameters of the gap voltage is the steepness of the rising flank of the current pulse, in particular the rising from an initial current level to the desired pulse current amplitude Iₑ. Another important pulse feature is the current pedestal I_{ped}, i.e. the initial machining current which can be controlled in the same way, pulsewise.

The shape characteristics is preferably determined by means of experiments. Different shape characteristics are applied to machine a workpiece and machining results including one or more of the electrode wear, the material removal rate, the surface roughness, and the recast layer thickness are measured. Based on these experimental data, the lookup table is generated. Specific machining conditions including the shape characteristics and the measured machining results achieved with said conditions can be used to train an algorithm by which the shape characteristics for new machining condition are determined. Machine learning may be thus be used to identify suitable discharge current shape characteristics, to be stored e.g. in the look-up table. Normally, two power generators, or generator modules are included in the machine tool. The first power generator is turned on to apply the open voltage and to generate the ignition. For example, the first power generator is a high-voltage power generator providing an open voltage which typically is in the range of 80V to 300V. After the ignition, a second power generator is turned on to apply the machining current pulse for erosion. For example, the second power generator is a current generator.

As said, an embodiment of the invention may use the fall time t_{f}, respectively the normalized value to determine the shape characteristics to be applied for the present current pulses. However, calculating the fall time t_{f} needs time, e.g. a computation time t_{comp} 200 nS. During this time, a current Iₒ is preferred to be applied to the gap to avoid the extinction of the discharge channel.

Therefore, in a preferred variant, a defined auxiliary current Iₒ is issued by the first generator and said auxiliary current is issued at least until the current pulse is switched on, preferably during the whole pulse.

According to a preferred embodiment of the invention, an average value of the time parameter of a plurality of voltage pulses is computed and used to determine the shape characteristics of the current pulse, and the determined shape characteristics is applied for a group of subsequent machining discharge pulses. For example, the ignition delay time of a succession of 20 voltage pulses are used to determine an average ignition delay time t_{d_avg}, and said average ignition delay time or a normalized value thereof is used for the determination of the shape characteristics which apply to e.g. the subsequent 20 current pulses. In this case, the shape characteristics of the subsequent 20 current pulses are same. Nevertheless, the process is continuously monitored to identify e.g. short pulses.

Although this variant is less reactive than the one in which the current pulse shape is adjusted pulsewise, it is still advantageous and effective. This is due to the fact that the discharge conditions are related to the gap width, and that the effective gap width can only be adjusted comparably slowly compared to the discharge pulse parameters. For this reason such procedure is considered as a real-time procedure.

Depending on the application, priority of the technological result may vary. In order to enhance the flexibility of the method, the memory includes a set of look-up tables, in which the shape characteristics of the current pulse is stored. The look-up table is selected according to the priority of the technological results, in particular low electrode tool wear, and high material removal rate. For example, for producing the microconnectors using EDM, the wear has dramatically negative impact on the quality of the produced part, e.g. the shape and reliable plugging of the microconnector, thus low wear has a high priority for this application. However, for drilling a hole using EDM, the wear is less important than the material removal rate.

It is known that the wear is mainly caused at the beginning when the current pulse is applied. According to the invention, to ensure both requirements of low wear and high material removal rate, the current impulses are adaptively shaped in real time, in consideration of the actual discharge condition, which is represented by the observed time parameter t_{d %} and/or t_{f100}.

In one variant, the shape characteristics of the current pulse include a first shape feature and a second shape feature, the first shape feature is a pedestal of the current pulse and the second shape feature is a ramp of the current pulse. Here, the shape of the current pulse is substantially defined by the shape features I_{ped} and d_{Iramp}.

In one variant, the first shape feature is configured to maintain the discharge and the second shape feature is configured to optimise the material removal rate and tool wear.

The current ramp can be defined by indicating an increment dIᵣₐₘₚ per unit time dt, where the current rises from I_{ped} to Iₑ with a gradient dIᵣₐₘₚ/dt. Alternatively, the rising time tᵣₐₘₚ in which the current rises from I_{ped} to Iₑ can be indicated to define the steepness of the current slope. Here the look-up table comprises the values of the rising time tᵣₐₘₚ instead of the increments dIᵣₐₘₚ.

The ignition delay time t_{d} is measured as soon as a gap voltage drops below a threshold voltage level, then the fall time t_{f} is measured, and the pedestal and the ramp of the current pulse is adapted in real time for the very same discharge as a function of the ignition delay time and/or the fall time.

For sake of simplicity the disclosed invention mentions pedestal and ramp of a trapezoid, but several other shapes are applicable, such as e.g. triangular, provided they reduce the tool electrode wear. The current pulse shapes comprise a rising flank with varying steepness. Moreover, the current may vary linearly, stepwise, or in any other way.

The method of the present invention can be applied to other electrical discharge machining methods, such as wire EDM and fast wire EDM (i.e. high-speed reciprocating wire EDM). In particular, the method of the present invention can be applied to wire EDM for trim cuts. In the case of fast wire EDM, the wire travels back and forth and thus is used several times. Here it is particularly important to achieve high cutting rate and to preserve the electrode, because the autonomy of the machine is determined by the electrode wire wearing. Here the method can be used for all cuts.

The inventive idea of adapting a pulse shape feature (e.g. pedestal and ramp) as a function of a time parameter can be applied for an individual pulse, i.e. the present current pulse, and/or for a plurality N of following current pulses. Moreover it is possible to compute averages of t_{d} and/or t_{f} over several pulses, retrieve the pulse shape based on said averages t_{d_avg} and/or t_{f_avg} and apply the retrieved pulse shape parameters to the present and following N pulses, to be synchronized with the comparably slow movements of the machine head.

As illustrated in FIG. 2, one sees that the process workpoint (on the horizontal coordinate axis) is a tradeoff between very low wear and high MRR. The disclosed inventive method improves greatly the process performance, by adjusting this workpoint in real time, for each pulse. A set of look-up tables is therefore preferably used, to continuously optimize the combination of low wear and high MRR, according to the desired result priority (e.g. extremely low wear).

The best combination of shape features such as current pedestal and current ramp in terms of low tool electrode wear and high MRR is advantageously found by repeating a given erosion test, collecting the current pulse settings (shape features I_{ped} and dIᵣₐₘₚ) and the resulting electrode wear and material removal rate, and by applying methods of artificial intelligence known in the art, such as Bayesian optimization or similar.

Thus, in one variant, the shape features included in the look-up tables are optimized in advance by iterative erosion tests. For instance, suitable combinations of the pedestal current and the current ramp are determined by executing a number of erosion tests in which the set pulse shape features are collected together with the resulting tool wearing and the material removal rate. In further, the shape features can be optimized by utilizing tools of artificial intelligence.

During the erosion process there are essentially front discharges and side discharges. The latter must be limited, since they enlarge the side gap and reduce the machining accuracy. Since the side gap is however always larger than the front gap, side discharges are characterized by a higher average erosion voltage U_{e_avg} and a quite longer average ignition delay t_{d_side}. The longer ignition delay has hence a double meaning: the current discharge is either a side discharge or a low wear front discharge, which could trigger a more energetic current pulse shape (e.g. as depicted in FIG. 9a according to the inventive method.

This kind of current pulse shape is beneficial for front discharges to increase the MRR, but undesired for side ones, since it would enlarge the side gap.

Therefore, according to a further embodiment, the inventive method is adapted to limit the side discharges using one or more of the variants explained hereafter.
by adapting the generator power supply voltage U_{HPS} in order to be just slightly higher than the erosion voltage U_{e_front} of the front discharges, but lower than the erosion voltage of the side discharges;
by cutting off the pulses having a delay time which is longer than a set reference ignition delay t_{dref_side};
by issuing a dedicated current pulse (exemplarily less energetic) for discharges having a delay time longer than a set reference ignition delay t_{dref_side}.

The first variant is disclosed in EP 2 848 349 which is incorporated by reference in the present application. In the second variant, the machining pulses having a delay time which is longer than a set reference ignition delay t_{dref_side} are cut off. In the third variant, a dedicated current pulse (exemplarily less energetic) is issued for discharges longer than a set reference ignition delay t_{dref_side}.

According to the present invention, a machine tool for electrical discharge machining of a workpiece by a tool electrode includes a power generator and a control unit. A plurality of discrete electrical discharge machining pulses are applied to a gap between the work piece and the tool electrode. An open voltage Uₒ is generated by the power generator and applied between the electrode and the work piece to induce a discharge. A gap voltage U_{Gap} is measured. At least one time parameter related to the gap voltage is computed by the control unit and, a shape characteristics of a current pulse is determined based on the determined at least one time parameter by the control unit. The current pulse is generated according to the determined shape characteristics and applied to the tool electrode.

### DRAWINGS

Preferred embodiments of the invention will now be detailed with reference to the attached drawings, in which

FIG. 1a is a schematic plot of a typical gap voltage, machining current pulse and oscillator clock pulse;

FIG. 1b is a schematic plot of a typical gap voltage, machining current pulse and oscillator clock pulse; and

FIG. 1c is a schematic plot of a typical gap voltage, machining current pulse and oscillator clock pulse;

FIG. 2 is a graph illustrating MRR, relative tool wear, and gap width as a function of the reference ignition delay t_{dref} in percent of the total pulse duration tᵢ, as known in the art;

FIG. 3 is a graph illustrating the dependency of the tool electrode wear on the fall time t_{f}, as known in the art;

FIG. 4 is a graph illustrating the dependency of the relative tool electrode wear on the reference ignition delay t_{dref}, as known in the art;

FIG. 5a is a schematic plot of a voltage pulse with a small tool electrode wear;

FIG. 5b is a schematic plot of a voltage pulse with a big tool electrode wear;

FIG. 6 is a schematic plot of the gap voltage, the corresponding current pulse and a t_{d %}-look-up table according to a first embodiment of the invention;

FIG. 7 is a schematic plot of the gap voltage, the corresponding current pulse and a t_{f}-look-up table according to a second embodiment of the invention;

FIG. 8 is a schematic plot of the gap voltage, the corresponding current pulse and a t_{d}+t_{f}-look-up table according to a third embodiment of the invention;

FIG. 9a is a schematic plot of the gap voltage with potentially low tool erosion wear and the corresponding current pulse according to an embodiment of the invention;

FIG. 9b is a schematic plot of the gap voltage with potentially high tool erosion wear and the corresponding current pulse according to an embodiment of the invention;

FIG. 10 is a schematic plot of a current pulse with characteristic shape features;

FIG. 11 is a schematic plot of a sequence of current pulses with varying pulse shape;

FIG. 12a is a schematic plot of exemplary erosion current pulses with various wear limiting shapes;

FIG. 12b is a schematic plot of exemplary erosion current pulses with various wear limiting shapes;

FIG. 12c is a schematic plot of exemplary erosion current pulses with various wear limiting shapes;

FIG. 12d is a schematic plot of exemplary erosion current pulses with various wear limiting shapes;

FIG. 12e is a schematic plot of exemplary erosion current pulses with various wear limiting shapes; and

FIG. 12f is a schematic plot of exemplary erosion current pulses with various wear limiting shapes;

### DESCRIPTION OF THE PREFERRED EMBODIMENTS

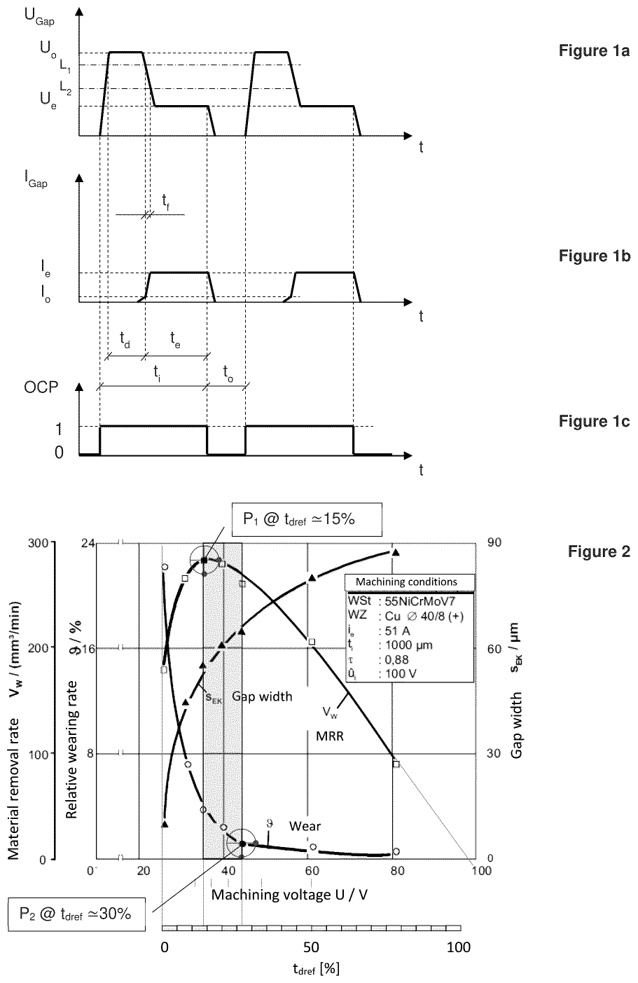

First, referring to FIGS. 1a and 1b there is illustrated the gap voltage and current profile of an ideal machining pulse as a function of time in a known die-sinking electrical discharge machine, with an anodic-poled machining electrode. FIG. 1c depicts the oscillator clock signal OCP controlling the pulse duration tᵢ of the machining pulses and the pulse pause to between two pulses.

To initiate the discharge channel, an open voltage is applied to the gap between the tool electrode and the workpiece. The ignition occurs after an ignition delay time t_{d}. With the ignition, the gap voltage falls from the value of the open voltage Uₒ with a variable slope, during a fall time t_{f}, to a discharge voltage Uₑ. It is possible that a small current Iₒ flows also during the fall time t_{f}, which is illustrated in the FIG. 1b showing the current flowing across the gap.

The material removal occurs during the discharge time tₑ, whereas the tool electrode wear occurs at the beginning of this time interval. During the ignition delay time t_{d} and in the pause time tₒ no machining current flows and there is practically no material removal.

The main aspect of the present invention is to reduce the tool electrode wear to the maximum to ensure a high copy precision and at the same time to achieve a high MRR.

FIG. 2 is taken from Fritz Klocke and Wilfried Konig, “Abtragen, Generieren, Laser-materialbearbeitung”, Springer Verlag, 4th edition, 1997, FIG. 2.20. This figure illustrates the gap width and technological parameters as a function of the machining voltage, and is complemented with a scale of the reference ignition delay t_{dref}[%] and with the labels P1 and P2, as discussed here below. The curves illustrate the tool wear and the material removal rate in t_{dref} relation to t_{dref} The reference ignition delay presents the percentage of the desired ignition delay time t_{dref} to pulse duration tᵢ. For this machining regime, the point P1 with the maximum MRR is found with a t_{dref} of about 15%, whereas the tool electrode wear increases sharply for values of t_{dref} smaller than 30%. The reference ignition delay t_{dref} is the imposed setpoint value for ignition delay t_{d}, i.e. the actual t_{d} is kept equal to t_{dref} by the servo control loop.

One sees that either the machining is carried out around the point P1, thus maximizing the MRR, or around the point P2, thus obtaining a small tool wear, or in a work point in between, representing a trade-off between MRR and tool wear.

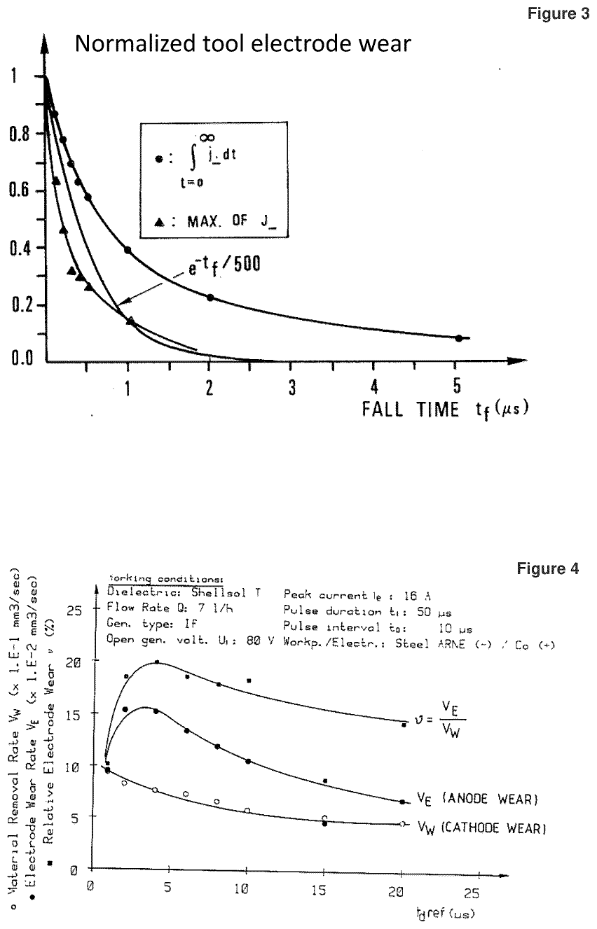

FIG. 3 illustrates the dependency of the tool electrode wear on the fall time t_{f}, as known in the art. This FIG. 3 is published by Dirk Dauw, dissertation KU Leuven, “On line identification and Optimization of electro-discharge machining”, 1985, as FIG. 3-28.

FIG. 4 is published as FIG. 1-10 in the same dissertation, and illustrates the dependency of the relative tool electrode wear on the reference ignition delay t_{dref}

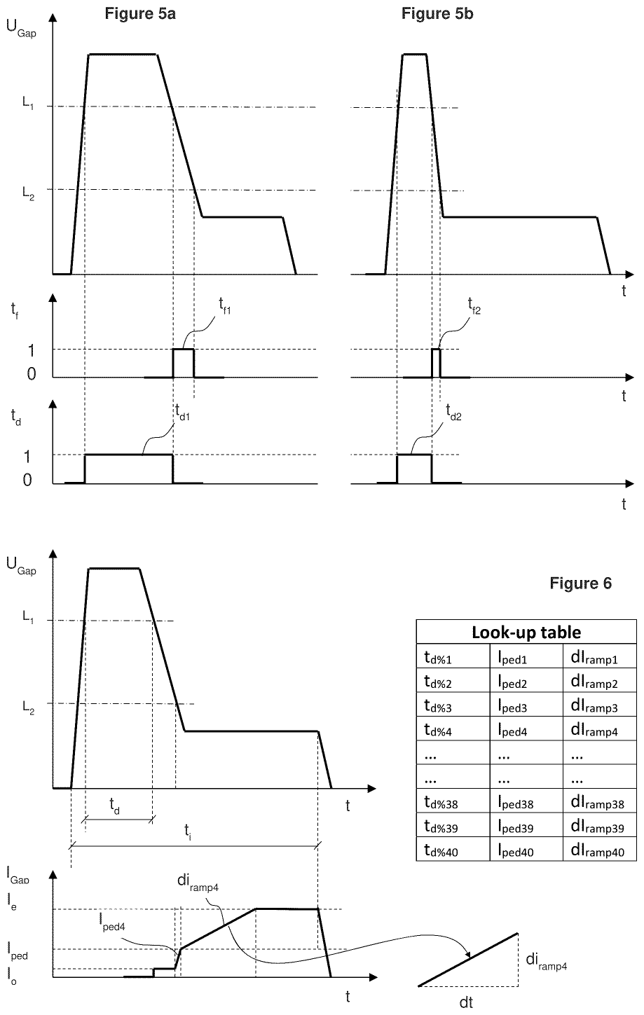

FIGS. 5a and 5b illustrate the two main wear indicators of an EDM machining pulse:
the fall time t_{f1} and t_{f2}; and
the ignition delay time t_{d1} and t_{d2}, respectively for a high wear (5a) and a low wear (5b) ideal machining pulse.

In this example the fall time t_{f} defines the time interval when the gap voltage falls from a first threshold voltage L₁ to a second threshold voltage L₂, and the ignition delay time t_{d} defines the time interval between the crossing of a first threshold voltage L₁ by the rising flank of the gap voltage and falling below the threshold voltage L₁ by the falling flank of the gap voltage.

A small or missing ignition delay means that the gap is still ionized, therefore the next discharge is going to occur at the same spot, or very near to the preceding discharge, causing in this way a localized high tool electrode wear.

As said, the tool electrode wear occurs at the beginning of the discharge, by the electronic current.

Another discharge pulse parameter that influences the electrode wear is the fall time t_{f}, since it correlates with the electron current density. The shorter the fall time is, the higher the current density is. Consequently, the tool electrode wear is higher with a shorter fall time than a longer fall time.

The method of the present invention provides the possibility to use one or both of these two indicators to predict the electrode wear caused by the present discharge, and to adapt the current pulse shape to optimize the tool wear and the material removal rate.

The current pulse shape is adapted in real time as a function of the time parameter t_{d} and/or t_{f} featured by the gap voltage, whereas the pulse shape features are retrieved from a fast memory to generate the present current pulse accordingly. These pulse shape features are illustrated exemplarily in FIG. 11. The auxiliary current Iₒ is omitted for clarity. One feature is I_{ped} which defines the pedestal current to be set at the beginning of the discharge current pulse. The second pulse shape feature is the current slope which is set after I_{ped} based on dIᵣₐₘₚ. Additional current pulse shape features may be specified and stored to get particular current pulse shapes, featuring e.g. additional slopes, steps, peaks, etc.

The slope of the current pulse can be defined as an increment dIᵣₐₘₚ of current per time unit dt, with a suitable predefined time unit dt. Alternatively the slope can be indicated as the current rising time, that is, the time between the reaching of the pedestal current and the reaching of the machining current Iₑ.

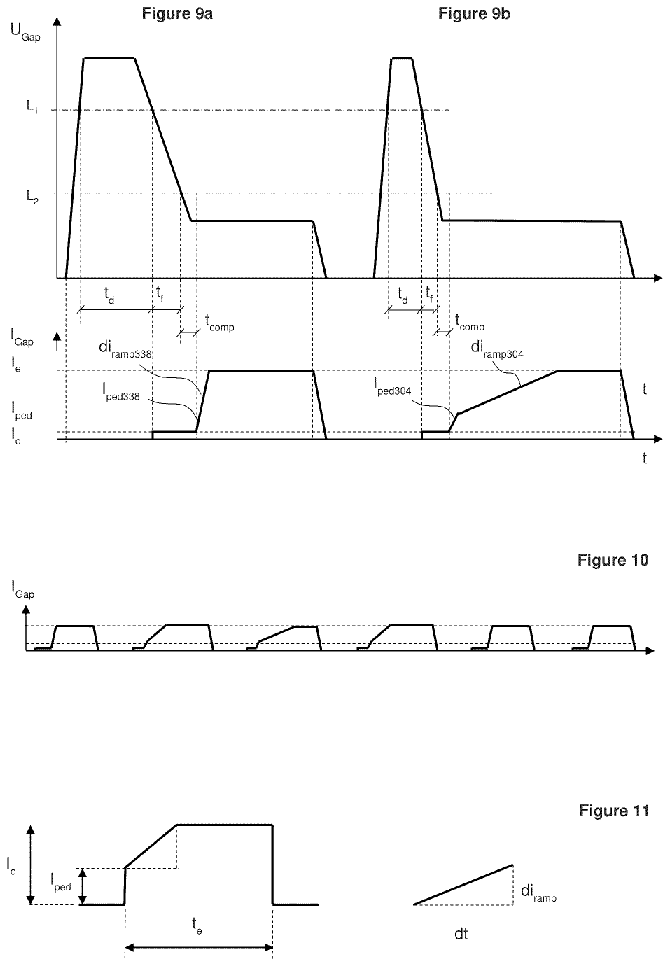

FIG. 9a shows a voltage pulse with a comparably long ignition delay time, and comparably long fall time. A suitable current pulse shape is quasi rectangular, providing high MRR. In contrast, FIG. 9b shows a voltage pulse with a short ignition delay time and steep falling flank. Here, a suitable current pulse comprises a pedestal current followed by current slope. FIG. 10 shows a sequence of current pulses, where the pulse shape is adapted in real time, pulsewise in consideration of the determined time parameters.

In some embodiments disclosed hereafter, during the ignition time and right thereafter, the generator issues a small auxiliary current Iₒ. This current is very small during the ignition delay and is illustrated in FIGS. 9a and 9b, during the fall time, before the switching of the machining current. For simplicity the current Iₒ is represented as a small current step. This current Iₒ is preferably applied to overcome the small gap conductivity, and to give time to the generator to prepare the main current pulse. The inventive method requires a t_{d} and/or t_{f} computation, preferably for each machining pulse.

These computations can be done in a computation time t_{c} of a few hundreds of ns, e.g. in a fast programmable gate array (FPGA). Nevertheless one must avoid that the discharge turns off and the plasma channel collapses, else a phase of instability would be triggered, where high frequency voltage and current spikes would enter an oscillation, causing a high wear. So, a minimal current is preferred to be sustained over the whole pulse.

FIG. 6 shows a first embodiment of the present invention. The method includes the following steps:
for at least one, preferably every single erosion pulse the ignition delay time t_{d} is determined;
the percent value of the ignition delay time t_{d} referred to the pulse duration tᵢ is computed, yielding the ignition delay t_{d %} (t_{d %1} to t_{d %40});
the resulting value is used as a pointer in a look-up table, which is schematically illustrated in FIG. 6;
the pulse shape features, e.g. a pedestal and ramp value for the current pulse are taken from a look-up table; and
the generator issues the current pulse accordingly.

As shown in the FIG. 6, the current pulse applied to the electrode features the auxiliary current Iₒ, a pedestal current I_{ped4} and a current ramp dIᵣₐₘₚ₄ at the beginning of the pulse. The auxiliary current serves to maintain the discharge channel after breakdown, until the machining current Iₑ is initiated. The pedestal current is to get a stable discharge condition as quick as possible. Following the current pedestal, the ramp serves to modulate the current density at the beginning of the current pulse, to keep the material removal rate high and the tool wear low, as the wear is especially caused at the beginning of the discharge by high current density.

FIG. 6 shows an example of 40 different values of shape characteristics of the current pulses stored in the look-up table, but the number of the values of shape characteristics is not limited. If the ignition delay has a normalized value of t_{d %1}, the values of I_{ped1} and dIᵣₐₘₚ₁ are used to generate the current pulses. If the ignition delay has a normalized value of t_{d %37}, the values of I_{ped37} and dIᵣₐₘₚ₃₇ are used to generate the current pulse for this pulse.

For example, using the ignition delay time, the current shape is formed and applied as follows: the open voltage is applied to the gap and the ignition delay time is determined and normalized with reference to the duration of the set oscillator clock pulse which corresponds to the pulse duration tᵢ. The normalized ignition delay time is used to determine the current pulse features from a look-up table as the one shown in FIG. 6. I_{ped4} defines the pedestal current of the machining pulse, and dIᵣₐₘₚ₄ defines the steepness of the following current ramp. By way of example, dIᵣₐₘₚ is defined as the increment of current per time unit dt, e.g. dt=20 ns.

In an exemplary embodiment, dIᵣₐₘₚ represents the multiplier of 20 ns units to increment the ramp current by 100 mA. In other words, to have a ramp of 0.1A/μs, or 0.1A/1000 ns, the multiplier is dIᵣₐₘₚ=1000 ns/20 ns=50, meaning one increment of 0.1A every 20 ns*50=1 μs. The auxiliary current Iₒ is applied immediately at the detection of the breakdown. The pedestal current I_{ped} is applied as soon as the current pulse features are determined based on the look-up table. The current rises sharply from the auxiliary current Iₒ to the value of the pedestal current I_{ped4}. Then, the current rises further from I_{ped4}, with a steepness dIᵣₐₘₚ₄/dt, to the desired machining current Iₑ which is maintained up to the end of the pulse.

Preferably, the time parameters of the present voltage pulse are used to determine the shape characteristics for the present current pulse only. Alternatively, the time parameters t_{d} and/or t_{f} of a plurality of machining impulses are averaged and/or these values are used to determine the shape characteristics for a present and a plurality of successive the current pulses.

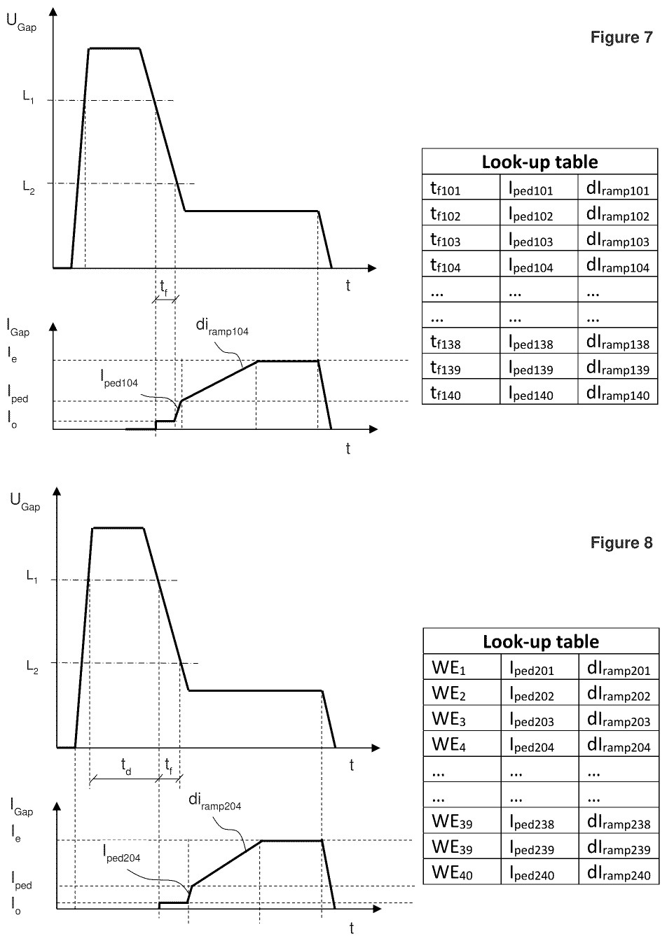

FIG. 7 illustrates a second embodiment of the present invention, which includes the following steps:
for every single erosion pulse the fall time t_{f} is measured;
the measured value is normalized, e.g. by rounding to 100 ns units, yielding t_{f100} (t_{f101} to t_{f140});
the resulting value is used as a pointer in a look-up table, which is schematically illustrated in FIG. 7;
the pulse shape features, e.g. a pedestal and ramp value for the current pulse are taken from the look-up table;
the generator issues the current pulse accordingly.

As shown in the FIG. 7, the current pulse applied to the electrode features an auxiliary current Iₒ, a pedestal value I_{ped104} and a current ramp dIᵣₐₘₚ₁₀₄.

For example, using the fall time t_{f} of the gap voltage, the current shape is formed and applied as follows: the open voltage is applied to the gap and the fall time is determined and rounded. The rounded fall time, e.g. t_{f104} is used to determine the current pulse features from a look-up table which comprises for instance 40 different values of shape characteristics of the current pulses, as the one shown in FIG. 7. I_{ped104} defines the pedestal current to be applied, and dIᵣₐₘₚ₁₀₄ defines the steepness of the following current ramp. The current is applied in the same way as discussed with reference to FIG. 6.

FIG. 8 illustrates a third embodiment, in which a combination of both time parameters of the gap voltage are used to determine the current pulse shape characteristics, where following steps are carried out:
For every single erosion pulse the ignition delay time t_{d} and the fall time t_{f} are measured and normalized, yielding the ignition delay time t_{d %} and the fall time t_{f100};
A wear evaluation function is created, exemplarily similar to:

WEₙ=k1*(100−t_{d %})+k2*t_{f100}

Where k1 and k2 are fitting coefficients found by application tests;
WEₙ is an index to a look-up table that yields the pulse shape characteristics, e.g. a pedestal and ramp value in consideration of the normalized delay time t_{d %} and fall time t_{f100};
The pulse generator outputs a current shape accordingly.

For example, using the ignition delay time t_{d} and the fall time t_{f} of the gap voltage, the current shape is formed and applied as follows: the open voltage is applied to the gap and the ignition delay time t_{d} is determined and normalized e.g. as described with reference to the first embodiment. Moreover, the fall time t_{f} is determined and rounded, e.g. as described with reference to the second embodiment. The wear evaluation function including the normalized ignition delay time t_{d %} and the fall time t_{f100} of the gap voltage is computed. The output of the wear evaluation function, e.g. WE₃ is used as a pointer to determine the current pulse features from the look-up table of FIG. 8. The current features are applied in the same way as for the case of the first and second embodiment.

These steps can be implemented using fast electronics in order to react within few hundreds of nanoseconds.

The pulse features are advantageously pre-computed and stored in a fast memory, e.g. used as a look-up table.

During this computation time, the current Iₒ is applied to avoid the discharge extinction.

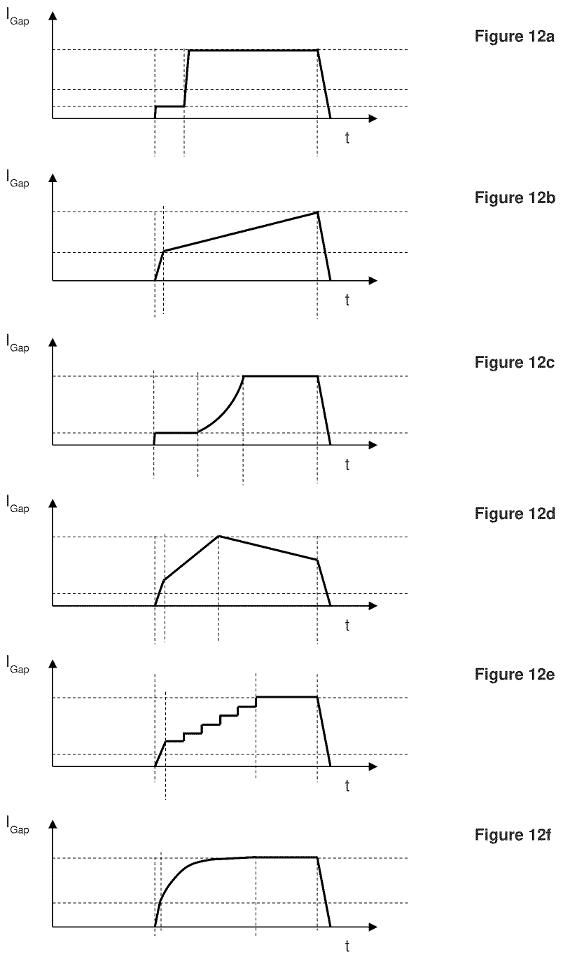

The current pulse shape is not limited to the variants outlined above. FIGS. 12a-12f shows several examples of current pulses with other shapes, which can be applied to the tool electrode. The number of the pulse shape features is not limited to one or two; the current pulse shape may be defined by an arbitrary number of features, however this number should be limited to limit the complexity. In particular, the current pulses features a pedestal at the beginning of the current pulse and a current ramp. FIG. 12a shows a current pulse having the auxiliary current followed by the pedestal and current ramp rising with the same steepness. Such pulse is very effective in terms of MRR, but could be undesirable in terms of electrode wear. FIG. 12b shows a current pulse with a pedestal and a ramp having a moderate slope. FIG. 12c shows a variant that the current pulse has no pedestal, but an initial current followed by a rising current profile and a phase in which the machining current is maintained till the switch off. FIG. 12d shows the example of applying a rising flank followed by a falling flank. FIG. 12e shows a current pulse in which the slope is obtained by stepwise increase the current. FIG. 12f shows a current pulse featuring a pedestal current followed by a rising current profile.

The invention is supported by certain exemplary embodiments. It goes without saying that the person skilled in the art may consider alternative embodiments by which the current pulse shape is adapted to the relevant voltage pulse characteristic, in real time. For instance, an ignition delay time may be rounded down to full microseconds, and directly used as a pointer to address the suitable prestored current shape.

The embodiments discussed herein feature an auxiliary current Iₒ which may have a different shape and duration than shown, or be omitted entirely.

Preferably, the discharge time tₑ is a fixed time (so called isoenergetic pulses, when rectangular shaped impulses are used), but this is not imperative. For instance, the discharge time tₑ can be controlled as a function of the pulse shape, such as to still get isoenergetic machining pulses, even when using non-rectangular shaped pulses.

On the other hand, while keeping the discharge time tₑ constant, the current pulse shape characteristics can be adapted such as to still get isoenergetic machining pulses, or to at least to at least partially reduce the difference of the energy of pulses. For instance, for current pulse shapes displaying a small initial slope, the current is highly increased in the course of the discharge time tₑ to a level above of the current of a corresponding rectangular pulse.

Moreover, the number of the prestored current pulse shapes and the number of features of the pre-stored current pulse shapes can be set as needed. For instance, the invention was presented using exemplarily 40 current pulse shapes. However, the advantages of the invention are already appreciable with as few as two different pulse shapes, that is, a first pulse shape with a moderate slope and a second pulse shape with a rather steep slope. In further one current pulse shape may be used by default, and one or more other may replace the default current pulse shape depending on the value of the time parameter featured by the gap voltage.

What is claimed is:

1. A method for electrical discharge machining of a workpiece by a tool electrode, wherein a plurality of discrete electrical discharge machining pulses are applied to a gap between the work piece and the tool electrode, comprising wherein,
an open voltage Uₒ is applied between the electrode and the work piece to induce a discharge;
a gap voltage U_{Gap} is measured;
at least one time parameter related to the gap voltage is computed,
a shape characteristics of a current pulse is determined based on the determined at least one time parameter, and
the current pulse is generated according to the determined shape characteristics and applied to the tool electrode.

2. The method for the electrical discharge machining according to claim 1, whereas the time parameter is an ignition delay time t_{d} and/or a fall time t_{f}.

3. The method for the electrical discharge machining according to claim 1, wherein
the determined time parameter is normalized, in particular with reference to the pulse duration tᵢ, or with reference to a reference timeframe T_{ff}, preferably
the normalized value of the time parameter is used as a pointer to a memory location that contains the shape characteristics of the current pulse.

4. The method for the electrical discharge machining according to claim 3, wherein a combination of normalized values of two time parameters, in particular the combination of the normalized ignition delay time t_{d %} and the normalized fall time t_{f100} is used as a pointer to a memory location that contains the shape characteristics of the current pulse.

5. The method for the electrical discharge machining according to claim 1, wherein a defined auxiliary current Iₒ is issued at least until the current pulse is switched on, preferably during the whole pulse.

6. The method for the electrical discharge machining according to claim 1, wherein an average value of the time parameter of a plurality of consecutive voltage pulses is computed and used to determine the shape characteristics of the current pulse and the determined shape characteristics is applied for a plurality of subsequent machining discharge pulses.

7. The method for the electrical discharge machining according to claim 1, wherein the memory includes a set of look-up tables, in which the shape characteristics of the current pulse is stored and the look-up table is selected according to the given priority of the technological results to be achieved, in particular low wear or high material removal rate.

8. The method for the electrical discharge machining according to claim 1, wherein the shape characteristics of the current pulse includes a first shape feature and a second shape feature, whereas the first shape feature is a pedestal of the current pulse and the second shape feature is a ramp of the current pulse.

9. The method for the electrical discharge machining according to claim 8, and the first shape feature is configured to maintain the discharge and the second shape feature is configured to optimise the material removal rate and tool wear.

10. The method for the electrical discharge machining according to claim 1, wherein the shape features included in the look-up tables is optimized in advance by iterative erosion tests.

11. The method for the electrical discharge machining according to claim 1, wherein a discharge voltage Uₑ of each electrical discharge pulses is acquired and stored, whereby front discharges are determined out of a plurality of successive discharges based on the voltage U_{e_front} of said front discharges.

12. The method for the electrical discharge machining according to claim 11, wherein a generator power supply voltage is adapted, as a function of the determined front discharge voltage U_{e_front} in order to be just slightly higher than the erosion voltage of the front discharges U_{e_front} but lower than the erosion voltage of the side discharges U_{e_side}.

13. The method for the electrical discharge machining according to claim 1, wherein the machining pulses having a delay time which is longer than a set reference ignition delay t_{d_side} are cut off.

14. The method for the electrical discharge machining according to claim 1, wherein a dedicated current pulse (exemplarily less energetic) for discharges longer than a set reference ignition delay t_{d_side} is issued.

15. The method for the electrical discharge machining according to claim 1, wherein the discharge machining is a die-sinking electrical discharge machine, a wire electrical discharge machine or a fast-wire electrical discharge machine.

16. A machine tool for electrical discharge machining of a workpiece by a tool electrode including a power generator and a control unit, wherein a plurality of discrete electrical discharge machining pulses are applied to a gap between the work piece and the tool electrode, comprising wherein, an open voltage Uₒ is generated by the power generator and applied between the electrode and the work piece to induce a discharge;
a gap voltage U_{Gap} is measured;
at least one time parameter related to the gap voltage is computed by the control unit,
a shape characteristics of a current pulse is determined based on the determined at least one time parameter by the control unit, and
the current pulse is generated according to the determined shape characteristics and applied to the tool electrode.
